(19) United States
(12) Patent Application Publication
(10) Pub. No.: US 2024/0009687 A1
(43) Pub. Date: Jan. 11, 2024

(54) NOZZLE STRUCTURE AND SPRAY PIPE ASSEMBLY

(71) Applicant: Shanghai Kohler Electronics, Ltd., Shanghai (CN)

(72) Inventor: Yiguo Fang, Shanghai (CN)

(21) Appl. No.: 18/215,065

(22) Filed: Jun. 27, 2023

(30) Foreign Application Priority Data
Jul. 5, 2022 (CN) 202221718772.5

(51) Int. Cl. B05B 1/14; B05B 15/65

(52) U.S. Cl. CPC B05B 1/14; B05B 15/65

(57) ABSTRACT

A nozzle structure includes a main body having a cavity; a front cover plate connected to a front end of the main body and having spray holes, the spray holes spaced apart from each other and disposed on the front cover plate; and a pipe body connected to a rear end of the main body and configured to be connected to a spray pipe. The spray holes are distributed along a length direction of the front cover plate.

### CROSS REFERENCE TO RELATED APPLICATION

This application claims the benefit of priority to: Chinese Patent Application No. 202221718772.5 filed in the Chinese Intellectual Property Office on Jul. 5, 2022, which is hereby incorporated by reference in its entirety.

### FIELD

The present disclosure relates to the field of toilet spray pipe and particularly relates to a nozzle structure and a spray pipe assembly.

### BACKGROUND

A smart toilet comprises a spray pipe device, and the spray pipe device comprises a spray pipe and a nozzle mounted on the front end of the spray pipe. Users can turn on the spray pipe device as needed, and the nozzle sprays water to clean the user's private parts.

The nozzle usually has a single-hole structure with a small spraying area, and the spraying effect still needs to be improved.

In view of this, it is necessary to provide a nozzle structure and a spray pipe assembly that can increase the spraying area.

### SUMMARY

The present disclosure aims to overcome the above defects and provide a nozzle structure and a spray pipe assembly that can increase the spraying area.

According to an embodiment of the present disclosure, a nozzle structure comprises a main body having a cavity, a front cover plate having a plurality of nozzle holes (e.g., spray holes), and a pipe body configured to be connected to a spray pipe.

The front cover plate is connected to a front end of the main body, and the pipe body is connected to a rear end of the main body.

A plurality of spray holes is provided at intervals on the front cover plate, and the plurality of the spray holes are arranged in a straight line or in a curved line on the front cover plate.

In another embodiment of the present disclosure, at least one of the spray holes is in an inclined arrangement on the front cover plate.

Along a rear-to-front direction, the spray holes arranged in the inclined arrangement gradually extend towards an edge of the front cover plate.

In another embodiment of the present disclosure, a length of the front cover plate is greater than a width of the front cover plate, and the plurality of the spray holes are arranged at intervals along a length direction of the front cover plate.

In another embodiment of the present disclosure, along the rear-to-front direction of the cavity, a length, corresponding to the length of the front cover plate, of the cavity increases.

In another embodiment of the present disclosure, a wall of the cavity has a guiding ramp configured to guide water flow toward the spray holes.

In another embodiment of the present disclosure, a rear part of the pipe body has an assembly mechanism configured to be assembled with a positioning pin on the spray pipe in a snap-fit manner.

The assembly mechanism comprises a slot configured to be in snap-fit connection with the positioning pin and comprises a guide groove configured to guide the positioning pin to slide.

The guide groove is located behind the slot, and the guide groove extends from a rear end of the pipe body to the slot.

In another embodiment of the present disclosure, along the rear-to-front direction, a distance between groove walls on both sides of the guide grooves decreases.

In another embodiment of the present disclosure, each side of the opposite sides of the pipe body is provided with one assembly mechanism.

According to another embodiment of the present disclosure, a spray pipe assembly comprises a spray pipe and the nozzle structure according to any one of the above embodiments.

The pipe body is removably connected to the front end of the spray pipe.

In another embodiment of the present disclosure, the spray pipe is provided with a positioning pin, and the positioning pin is removably connected to assembly mechanism on the pipe body.

By adopting the technical solutions above, the present disclosure has the following beneficial effects:

In the nozzle structure and the spray pipe assembly provided according to the present disclosure, the front cover plate of the front end is configured with a plurality of spray holes, and the plurality of spray holes are arranged in a straight line or in a curved line on the front cover plate. Thus, the spraying area is increased and the spraying effect is improved.

### BRIEF DESCRIPTION OF THE FIGURES

With reference to the drawings, the contents disclosed by the present disclosure should be more easily understood. It should be understood that these drawings are merely used for illustration and are not intended to limit the protection scope of the present disclosure. In the drawings:

FIG. 1 is a perspective view of the nozzle structure according to an example of the present disclosure;

FIG. 2 is a top view of the nozzle structure shown in FIG. 1;

FIG. 3 is a section view of the nozzle structure along a guide groove shown in FIG. 1;

FIG. 4 is a schematic diagram of an inclined arrangement of spray holes on a front cover plate;

FIG. 5 is a perspective view of the spray pipe assembly according to an example of the present disclosure; and

FIG. 6 is a schematic diagram of a structure of a spray pipe.

FIG. 7 is a flow chart of a method for assembling the spray pipe assembly according to an example of the present disclosure.

### DETAILED DESCRIPTION

The specific embodiments of the present disclosure are further described with reference to the drawings hereinafter. Same or equivalent parts are denoted by same reference numerals. It should be noted that the terms “front”, “back”, “left”, “right”, “up” and “down” used in the following description refer to the directions in the drawings, and the terms “inner” and “outer” refer to the directions towards or far away from geometric centers of specific parts respectively.

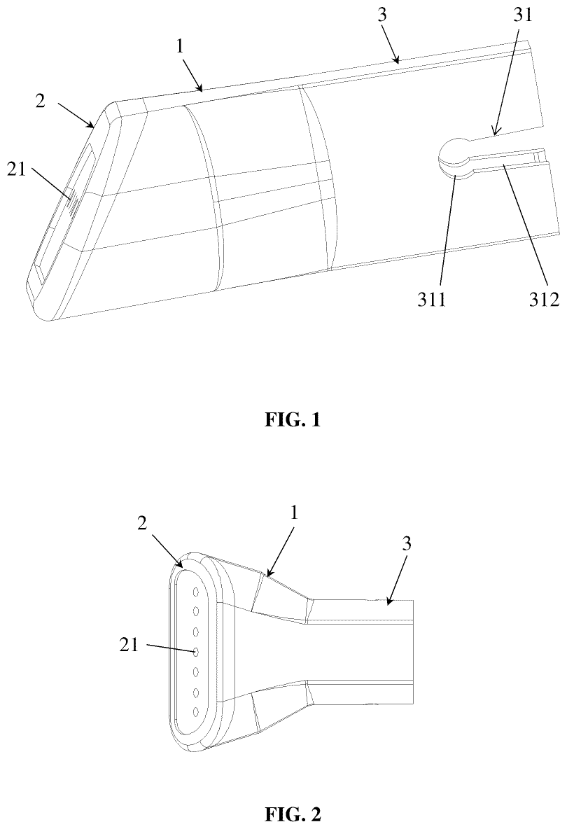

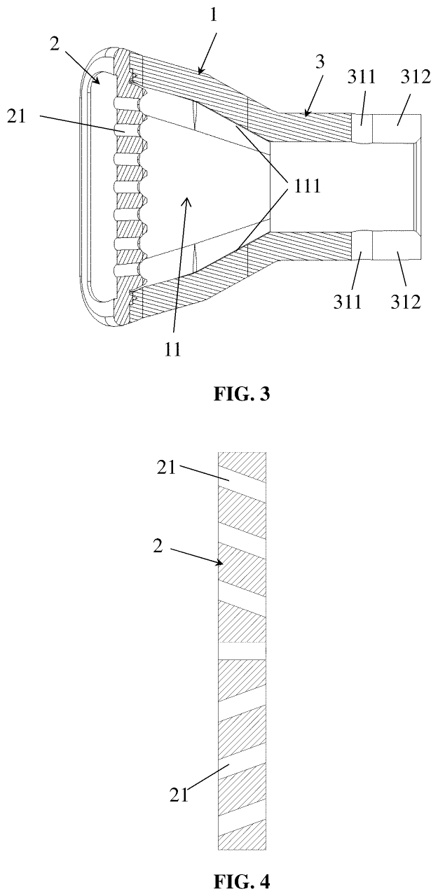

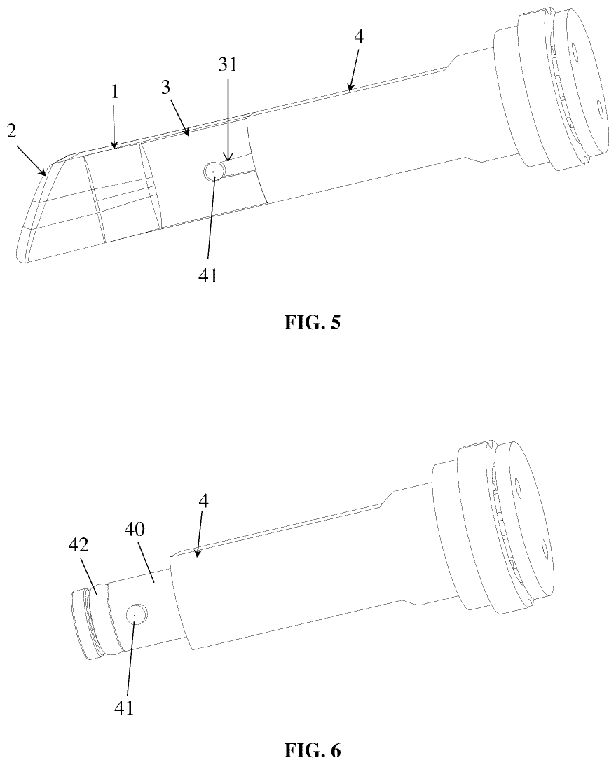

FIG. 1 is a perspective view of the nozzle structure according to an example of the present disclosure. FIG. 2 is a top view of the nozzle structure shown in FIG. 1. FIG. 3 is a section view of the nozzle structure along a guide groove shown in FIG. 1. FIG. 5 is a perspective view of the spray pipe assembly according to an example of the present disclosure. FIG. 6 is a schematic diagram of a structure of a spray pipe. As shown in FIG. 1, FIG. 2, and FIG. 3 and in combination with FIG. 5 and FIG. 6, the nozzle structure provided by an embodiment of the present disclosure comprises a main body 1 comprising a cavity 11, a front cover plate 2 comprising a plurality of spray holes 21, and a pipe body 3 configured to be connected to a spray pipe 4.

The front cover plate 2 is connected to a front end of the main body 1, and the pipe body 3 is connected to a rear end of the main body 1.

The plurality of spray holes 21 is provided at intervals (e.g., evenly or unevenly spaced apart from each other) on the front cover plate 2, and the plurality of spray holes 21 is arranged in a straight line or in a curved line on the front cover plate 2 (e.g., along a length direction of the front cover plate 2).

The present disclosure provides a nozzle structure configured to be connected a front end of the spray pipe 4 shown in FIG. 5 and FIG. 6.

The nozzle structure comprises a front cover plate 2, a main body 1, and a pipe body 3 connected in sequence from the front end of the main body 1 to the rear end of the main body 1, and the front cover plate 2, the main body 1, and the pipe body 3 form a housing of the nozzle structure. The main body 1 and the pipe body 3 can be formed integrally. The front cover plate 2, the main body 1, and the pipe body 3 may be plastic.

The main body 1 comprises a cavity 11, and a central hole of the pipe body 3 is in air communication with the cavity 11. The pipe body 3 is configured to be assembled and installed with the spray pipe 4. Water in the spray pipe 4 can enter the cavity 11 through the center hole of the pipe body 3.

The front cover plate 2 is connected to the front end of the main body 1 and covers a front opening of the cavity 11. The front cover plate 2 is connected to the main body 1 in a sealed manner. In an embodiment, the front cover plate 2 is connected to the main body 1 by ultrasonic welding.

In order to expand the spraying area of the nozzle structure and thus improve the spraying effect, the plurality of spray holes 21 is provided on the front cover plate 2, and the plurality of spray holes 21 is arranged at intervals (e.g., evenly or unevenly spaced apart from each other) on the front cover plate 2, and the plurality of spray holes 21 are arranged in a straight line or in a curved line on the front cover plate 2 (e.g., along the length direction of the front cover plate 2). The curved-line arrangement may be, for example, a wave-shaped arrangement or an arc-shaped arrangement, etc. In general, the plurality of spray holes 21 are distributed from one side of the front cover plate 2 to the other side of the front cover plate 2.

When the nozzle structure sprays the water, the water in the cavity 11 is sprayed out simultaneously through the plurality of spray holes 21. The plurality of spray holes 21 arranged in the straight line or in the curved line may expand the spraying area, increase the spraying region, and improve the spraying effect.

FIG. 4 is a schematic diagram of an inclined arrangement of spray holes on a front cover plate. In an embodiment, at least one spray hole 21 is obliquely arranged on the front cover plate 2 as shown in FIG. 4. The spray holes 21 obliquely arranged gradually extends towards an edge of the front cover plate 2 in a rear-to-front direction of the front cover plate 2.

In this embodiment, one or more spray holes 21 are oblique holes obliquely arranged on the front cover plate 2 or obliquely extends on the front cover plate 2. In the rear-to-front direction of the front cover plate 2 or in a flowing direction of the water, the obliquely arranged spray holes 21 extends towards the edge of the front cover plate 2 so that the oblique holes have an expanded shape in the rear-to-front direction of the front cover plate 2 to increase the spraying area.

A middlemost spray hole 21 may be a straight hole perpendicular to the length direction of the front cover plate 2, and the spray holes 21 on both sides of the middlemost spray hole 21 are oblique holes. The oblique holes on both sides of the straight hole (e.g., the middlemost spray hole 21) are arranged symmetrically.

In another embodiment, as shown in FIG. 2 and FIG. 3, a length of the front cover plate 2 is greater than a width of the front cover plate 2, and the plurality of spray holes 21 are arranged at intervals (e.g., evenly or unevenly spaced apart from each other) along the length direction of the front cover plate 2.

In this embodiment, the front cover plate 2 is a rectangular plate, and the plurality of spray holes 21 are arranged in a straight line or in a curved line along the length direction of the front cover plate 2.

In practice, the length direction of the front cover plate 2 is parallel with a width direction of the toilet, and thus the spraying area of the nozzle structure along the width direction of the toilet may be expanded.

In an embodiment, as shown in FIG. 3, in a rear-to-front direction of the cavity 11, a length, corresponding to the length of the front cover plate 2, of the cavity 11 gradually increases.

In this embodiment, the cavity 11 has a flared shape or a flattened and expanded shape. In a direction from the pipe body 3 to the front cover plate 2, the length, corresponding to the length of the front cover plate 2, of the cavity 11 gradually increases, to be adapted for a plurality of spray holes 21 arranged at intervals (e.g., evenly or unevenly spaced apart from each other) along the length direction of the cover plate 2, to guide the water in the cavity 11 to flow towards the spray holes 21.

In an embodiment, as shown in FIG. 3, each wall of the cavity 11 comprises a guiding ramp 111 configured to guide the water flow towards the spray holes 21. The guiding ramp 111 is obliquely arranged, and a distance between the guiding ramp 111 and a central axis of the pipe body 3 gradually increases in the rear-to-front direction of the cavity 11, and the water flowing from the pipe body 3 can be guided to the spray holes 21 at both ends of the cavity 11.

As needed, multi-surface guiding ramps 111 (e.g., a plurality of guiding ramps) can be arranged on the walls of the cavity 11 along a front-to-rear direction of the cavity 11. Inclination angles, e.g., with respect to the central axis of the pipe body 3, of two adjacent guiding ramps 111 can be different, but each guiding ramp 111 is gradually expanded (e.g., opened) in a rear-to-front direction to meet the needs of evacuating or guiding the water.

In an embodiment, as shown in FIG. 1, FIG. 3, FIG. 5, and FIG. 6, a rear part of the pipe body 3 comprises an assembly mechanism 31 configured to be engaged (e.g., in snap-fit connection) with the positioning pin 41 on the spray pipe 4.

The assembly mechanism 31 comprises a slot 311 configured to be in snap-fit connection with the positioning pin 41 and comprises a guide groove 312 configured to guide the positioning pin 41 to slide towards the slot 311.

The guide groove 312 is located at a rear end of the slot 311, and the guide groove 312 extends from a rear end of the pipe body 3 to the slot 311.

In this embodiment, the rear part of the pipe body 3 has an assembly mechanism 31 configured to be in snap-fit connection with the positioning pins 41 on the spray pipe 4.

The assembly mechanism 31 comprises a slot 311 and a guide groove 312. The guide groove 312 is located at the rear end of the slot 311, and the guide groove 312 extends from the rear end of the pipe body 3 to the slot 311.

The guide groove 312 is configured to guide the positioning pin 41 into the slot 311, and after the positioning pin 41 is slid into the slot 311, the positioning pin 14 is stuck in the slot 311, and thus the pipe body 3 is assembled with the spray pipe 4.

To disassembly the spray pipe 4 and the pipe body 3, the pipe body 3 may be pulled forwards, the positioning pin 41 may be released from the slot 311, may enter into the guide groove 312, and then may leave the guide groove 312. Thus, the disassembly of the pipe body 3 and the spray pipe 4 is completed.

The slot 311 is a circular slot. A front opening of the guide groove 312 is connected to a middle of the circular slot, and a curved slot, which is below the front opening of the guide groove 312, serves as the main clamp function.

As needed, a ball head can be set on the positioning pin 41 configured to be in snap-fit connection with the curved slot.

In an embodiment, as shown in FIG. 1, along a rear-to-front direction of the guide groove 312, a distance between the walls on both sides of the guide groove 312 gradually decreases.

In other words, the guide groove 312 has a large opening at a rear end of the guide groove 312 and a small opening at a front end of the guide groove 312 to facilitate the entry of the positioning pin 41 through the large opening at the rear end of the guide groove 312 and then guide the positioning pin 41 into the slot 311.

In an embodiment, as shown in FIG. 3, an assembly structure 31 is provided on each of the opposite sides of the pipe body 3 configured to be assembled with the corresponding positioning pins 41 on each side of the spray pipe 4. Thus, the stability of the assembly of the pipe body 3 and the spray pipe 4 may be improved.

As shown in FIG. 5 and FIG. 6, the present disclosure provides a spray pipe assembly comprising a spray pipe 4 and a nozzle structure as described in any one of the above embodiments.

The pipe body 3 is removably connected to the front end of the spray pipe 4.

The spray pipe assembly provided by the present disclosure comprises a spray pipe 4 and a nozzle structure, and the pipe body 3 of the nozzle structure is connected to the front end of the spray pipe 4.

The descriptions related to the structure, construction, and working principle of the nozzle structure can be referred to the foregoing description of the nozzle structure, which are repeated herein.

The pipe body 3 and the spray pipe 4 have a variety of assembly methods, and the pipe body 3 and the spray pipe 4 can be, for example, connected via a sleeve connection.

In one of the connection methods, the front end of the spray pipe 4 has a thin plug end 40, and the plug end 40 comprises a seal ring 42.

To assembly the spray pipe 4 and the pipe body 3, the plug end 40 can be inserted into the pipe body 3, and the seal ring 42 can be used to seal the gap between the plug end 40 and the wall of the pipe body 3.

In an embodiment, as shown in FIG. 5 and FIG. 6, the spray pipe 4 comprises a positioning pin 41, and the positioning pin 41 is removably connected to the assembly mechanism 31 on the pipe body 3.

In this embodiment, the positioning pin 41 is disposed on the spray pipe 4, and a rear part of the pipe body 3 comprises an assembly mechanism 31. The assembly mechanism 31 comprises a slot 311 and a guide groove 312, and the guide groove 312 is located at a rear end of the slot 311, and the guide groove 312 extends from a rear end of the pipe body 3 to the slot 311.

The guide groove 312 is configured to guide the positioning pin 41 into the slot 311, and after the positioning pin 41 slides into the slot 311, the positioning pin 41 is stuck in the slot 311, and thus the pipe body 3 is assembled with the spray pipe 4.

To disassembly the spray pipe 4 and the pipe body 3, the pipe body 3 may be pulled forwards, and the positioning pin 41 may be released from the slot 311, may enter into the guide groove 312, and then may leave the guide groove 312. Thus, the disassembly of the pipe body 3 and the spray pipe 4 is completed.

The slot 311 is a circular slot. A front opening of the guide groove 312 is connected to a middle of the circular slot, and a curved slot, which is below the front opening of the guide groove 312, serves as the main clamping function.

As needed, the ball head part of the positioning pin 41 can be in snap-fit connection with the curved slot.

When the front end of the spray pipe 4 has a thin plug end 40, the positioning pin 41 is disposed on the plug end 40.

To sum up, according to the nozzle structure and the spray pipe assembly provided by the present disclosure, the front end of the front cover plate 2 is configured with a plurality of spray holes 21, and the plurality of spray holes 21 are arranged in a straight line or in a curved line on the front cover plate 2. Thus, the spraying area may be increased and the spraying effect may be improved.

The present disclosure also provides a toilet. The toilet comprises the toilet base bowl and the toilet rim according to any examples as described above.

In an embodiment, the toilet includes a base (e.g., a pedestal, bowl, etc.) and a tank. The base is configured to be attached to another object such as a drainpipe, floor, or another suitable object. The base includes a bowl, a sump (e.g., a receptacle) disposed below the bowl, and a trapway fluidly connecting the bowl to a drainpipe or sewage line. The tank may be supported by the base, such as an upper surface of a rim. The tank may be integrally formed with the base as a single unitary body. In other embodiments, the tank may be formed separately from the base and coupled (e.g., attached, secured, fastened, connected, etc.) to the base. The toilet may further include a tank lid covering an opening and inner cavity in the tank. The toilet may include a seat assembly including a seat and a seat cover rotatably coupled to the base. The toilet may further include a hinge assembly.

In another embodiment, the toilet may be a tankless toilet. The toilet includes a base and a seat assembly coupled to the base. The base includes a bowl, a sump disposed below the bowl, and a trapway fluidly connecting the bowl to a drainpipe or sewage line. The toilet includes a waterline that supplies the toilet with water. The toilet may further include a seat assembly including a seat and a seat cover rotatably coupled to the base. The toilets described above are provided herein as non-limiting examples of toilets that may be configured to utilize aspects of the present disclosure.

In some examples, a bidet may be included in a seat or pedestal of a toilet. In other examples, the bidet may be manufactured separately from and attached or coupled to a seat or pedestal of a toilet. The bidet includes a housing. The housing is configured to receive a flow of water through a housing inlet and dispense the flow of water from a housing outlet. The housing inlet and housing outlet may be located on opposite ends of the housing from one another, such that water may flow through the housing from the housing inlet to the housing outlet. In some examples, the housing further includes a chamber. As the housing receives the flow of water, the chamber may fill with water and provide a flow of water between the housing inlet and the housing outlet. The chamber may be configured to contain the flow of water and direct the flow of water from the housing inlet to the housing outlet. After the chamber has filled with water, the flow of water may travel along a substantially linear path between the housing inlet and the housing outlet. In some examples, one or more walls within the housing may be included to help direct a flow of water between the housing inlet and the housing outlet. The bidet may further include a housing inlet conduit configured to direct a flow of water to the housing inlet. The housing inlet conduit may be coupled to a water supply such as tank or waterline. The housing may further include a gear assembly or a portion of the gear assembly.

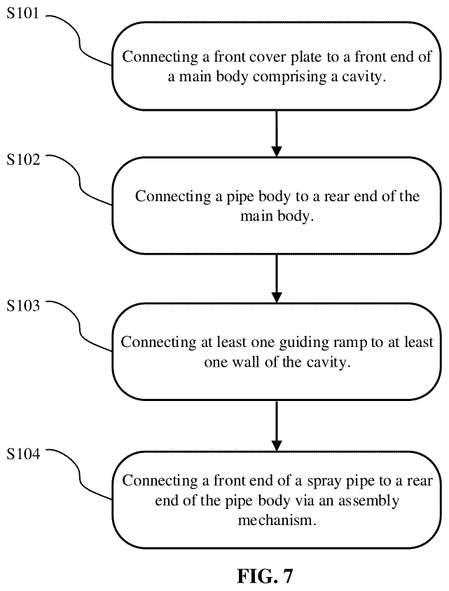

FIG. 7 is a flow chart of a method for assembling the spray pipe assembly according to an example of the present disclosure. The spray pipe assembly used in the method may be the spray pipe assembly according to any of the foregoing examples and may be configured to perform an operation, function, or the like as described in the present disclosure.

At act S101, a user may connect the front cover plate 2 to the front end of the main body 1 comprising the cavity 11.

Specifically, as noted above, the front cover plate 2 is connected to the front end of the main body 1 and covers a front opening of the cavity 11. The front cover plate 2 is connected to the main body 1 in a sealed manner. In an embodiment, the front cover plate 2 is connected to the main body 1 by ultrasonic welding.

At act S102, the user may connect the pipe body 3 to the rear end of the main body 1.

Specifically, as noted above, the main body 1 comprises the cavity 11, and the central hole of the pipe body 3 is in air communication with the cavity 11.

At act S103, the user may connect the at least one guiding ramp 111 to the at least one wall of the cavity 11 so as to guide the water to flow from the pipe body 3 towards the plurality of spray holes 21 disposed on the front cover plate 2.

Specifically, the plurality of guiding ramps 111 is connected to the at least one wall of the cavity 11 along the front-to-rear direction of the cavity 11. Each of the plurality of guiding ramps 111 is tilted at an angle with respect to the central axis of the pipe body 3. Angles, with respect to the central axis of the pipe body 3, of two adjacent guiding ramps 111 among the plurality of guiding ramps 111 are different.

At act S104, the user may connect the front end of the spray pipe 4 to the rear end of the pipe body 3 via the assembly mechanism 31.

Specifically, the spray pipe 4 is inserted into the pipe body 3 along the guide groove 312 of the assembly mechanism 31. The spray pipe is guided to slide towards the slot 311 of the assembly mechanism 31. The guide groove 312 is disposed at the rear end of the slot 311. The positioning pin 41 of the spray pipe 4 is engaged with the slot 311.

The above technical solutions may be combined as required to achieve the best technical effect.

The above are merely the principle and the embodiments of the present disclosure. It should be pointed out that, for those of ordinary skill in the art, other modifications may be made on the basis of the principle of the present disclosure, which should also be regarded as falling in the protection scope of the present disclosure.

1-10. (canceled)

11. A nozzle structure, comprising:
a main body comprising a cavity;
a front cover plate connected to a front end of the main body and comprising a plurality of spray holes, the plurality of spray holes spaced apart from each other and disposed on the front cover plate; and
a pipe body connected to a rear end of the main body and configured to be connected to a spray pipe,
wherein the plurality of the spray holes is distributed along a length direction of the front cover plate.

12. The nozzle structure according to claim 11, wherein at least one spray hole of the plurality of spray holes is obliquely disposed on the front cover plate;
wherein the at least one spray hole extends towards an edge of the front cover plate along a rear-to-front direction of the front cover plate.

13. The nozzle structure according to claim 11, wherein a length of the front cover plate is greater than a width of the front cover plate, and
wherein the plurality of spray holes is substantially arranged in straight line or in a curved line.

14. The nozzle structure according to claim 13, wherein a length,
corresponding to the length of the front cover plate, of the cavity increases in a rear-to-front direction of the cavity.

15. The nozzle structure according to claim 11, further comprising:
at least one guiding ramp disposed on at least one wall of the cavity and configured to guide water to flow from the pipe body towards the plurality of spray holes.

16. The nozzle structure according to claim 15, wherein a plurality of guiding ramps is disposed on the at least one wall of the cavity along a front-to-rear direction of the cavity, and
wherein angles, with respect to a central axis of the pipe body, of two adjacent guiding ramps among the plurality of guiding ramps are different.

17. The nozzle structure according to claim 11, further comprising:
an assembly mechanism disposed at a rear end of the pipe body and configured to be connected to a positioning pin of the spray pipe,
wherein the assembly mechanism comprises a slot configured to be engaged with the positioning pin and comprises a guide groove configured to guide the positioning pin to slide towards the slot,
wherein the guide groove is disposed at a rear end of the slot, and
wherein the guide groove extends from the rear end of the pipe body to the slot.

18. The nozzle structure according to claim 17, wherein the guide groove comprises:
a front opening connected to the slot; and
a curved slot disposed below the front opening and configured to be engaged with a head of the positioning pin.

19. The nozzle structure according to claim 17, wherein a distance between groove walls on both sides of the guide groove decreases along a rear-to-front direction of the guide groove.

20. The nozzle structure according to claim 17, wherein two assembly structure are disposed on both sides of the pipe body.

21. A spray pipe assembly, comprising:
a nozzle structure, comprising:
a main body comprising a cavity;
a front cover plate connected to a front end of the main body and comprising a plurality of spray holes, the plurality of spray holes spaced apart from each other and disposed on the front cover plate; and
a pipe body connected to a rear end of the main body,
a spray pipe comprising a front end removably connected to a rear end of the pipe body,
wherein the plurality of the spray holes is distributed along a length direction of the front cover plate.

22. The spray pipe assembly according to claim 21, wherein the spray pipe comprises a positioning pin, and
wherein the positioning pin is removably connected to an assembly mechanism of the pipe body.

23. The spray pipe assembly according to claim 22, wherein the assembly mechanism is disposed at the rear end of the pipe body,
wherein the assembly mechanism comprises a slot configured to be engaged with the positioning pin and comprises a guide groove configured to guide the positioning pin to slide towards the slot,
wherein the guide groove is disposed at a rear end of the slot, and
wherein the guide groove extends from the rear end of the pipe body to the slot.

24. The spray pipe assembly according to claim 23, wherein the guide groove comprises:
a front opening connected to the slot; and
a curved slot disposed below the front opening and configured to be engaged with a head of the positioning pin.

25. The nozzle structure according to claim 23, wherein two assembly structures are disposed on both sides of the pipe body and configured to be engaged with corresponding positioning pins disposed on both sides of the spray pipe.

26. The spray pipe assembly according to claim 23, further comprising:
a seal ring configured to seal a gap between the front end of the spray pipe and a wall of the pipe body.

27. A method for assembling a spray pipe assembly, the method comprising:
connecting a front cover plate to a front end of a main body comprising a cavity;
connecting a pipe body to a rear end of the main body;
connecting at least one guiding ramp to at least one wall of the cavity so as to guide water to flow from the pipe body towards a plurality of spray holes disposed on the front cover plate; and
connecting a front end of a spray pipe to a rear end of the pipe body via an assembly mechanism.

28. The method according to claim 27, wherein the connecting the at least one guiding ramp on the at least one wall of the cavity comprises:
connecting a plurality of guiding ramps to the at least one wall of the cavity along a front-to-rear direction of the cavity; and
tilting each of the plurality of guiding ramps at an angle with respect to a central axis of the pipe body,
wherein angles, with respect to the central axis of the pipe body, of two adjacent guiding ramps among the plurality of guiding ramps are different.

29. The method according to claim 28, wherein the connecting the front end of the spray pipe to the rear end of the pipe body via the assembly mechanism comprises:
inserting the spray pipe into the pipe body along a guide groove of the assembly mechanism;
guiding the spray pipe to slide towards a slot of the assembly mechanism, wherein the guide groove is disposed at a rear end of the slot; and
engaging a positioning pin of the spray pipe with the slot.

30. The method according to claim 29, further comprising:
sealing, by a seal ring, a gap between the front end of the spray pipe and a wall of the pipe body.
